(19) United States
(12) Patent Application Publication
(10) Pub. No.: US 2002/0164036 A1
(43) Pub. Date: Nov. 7, 2002

(54) Certification of transactions

(76) Inventors: Philippe Stransky, Marchissy (CH); Marco Sasselli, Chardonne (CH)

Correspondence Address: Clifford W. Browning, Woodard, Emhardt, Naughton, Moriarty & McNett, Bank One Center/Tower, 111 Monument Circle, Suite 3700, Indianapolis, IN, 46204-5137, US

(21) Appl. No.: 09/989,883

(22) Filed: Nov. 21, 2001

Related U.S. Application Data
(60) Provisional application No. 60/255,022, filed on Dec. 12, 2000.

(51) Int. Cl. H04L 9/00

(52) U.S. Cl. 380/285

(57) ABSTRACT

A method of production and distribution of asymetric public and private keys between a key generation centre and at least one user unit (DEC), the unit comprising a security module (SM), the method consisting in generating certificates comprising a public key and a private key in a first cryptographic unit (KPG), coding the private key by use of a service key in the first cryptographic unit (KPG) and storing the private key in a key memory (KPS), when sending the keys to a user unit, extracting the keys from the key memory (KPS), composing the certification with the public key, decoding the corresponding private key by use of the service key in a cryptographic security module and coding it with a transport key of the user.

This application claims the benefit of co-pending U.S. Provisional Patent Application Serial No. 60/255,022, filed Dec. 12, 2000.

The present invention concerns the field of secured transactions, particularly in the field of pay television.

### BACKGROUND OF THE INVENTION

With the development of traffic on open resources such as the Internet the need has quickly raised to be able to identify with certainty the person with whom one is going to communicate and to make incomprehensible the data exchanged between two units.

This is why web browsers include an encrypting module, of the SSL type, in order to code the data that is emitted from a user to a computer utility.

In this type of configuration the computer utility sends a certification to the user's address, said certification containing the public key of the centre. Once this certification is received, the data sent by the user are encrypted by the public key and sent to the centre. It is then only possible to decode these data with the private key of the centre, key that is secretly kept in the centre.

It is immediately necessary to point out that this system suffers from a first drawback which is that it only secures the data in one direction. The centre has no guarantee that the user is in fact who he/she pretends to be.

The other drawback is that the certification sent by the centre can be intercepted by a third person in order to substitute it with his/hers. It is the well known scenario of the “man in the middle”. All the data sent by the user are then decoded by the private key of the third person and then are encrypted by the public key of the centre. The centre and the user will not see in any way this intrusion as all the data sent by the user will be tampered with by the third person.

In a mutual identification configuration both speakers have a certification with a public and a private key. In order to obtain a certification there are several methods of which two examples are explained below:

The user access via Internet to a Certification Authority. After receiving certain personal data this Certification Authority sends the certification to the electronic postbox of the user. It has to be mentioned that at this stage the certification contains the private key and the public key.

The user goes in person to the Certification Authority and presents an identity card. The person receives a disc containing the certification to install it in his/her computer.

Although the first method has the advantage of simplicity, it does not guarantee a high level security.

On the contrary, the second method offers all the security guarantees but discourages many users in view of all the necessary steps to be taken.

### SUMMARY OF THE INVENTION

The object of the present invention is to generate and distribute certifications in a secure way with no annoyance for the user and guaranteeing the identity data of the receiver.

This object is achieved by a distribution method of asymetric keys, public and private keys, between a key centre and at least one user unit, said unit comprising a security module, said method consisting in generating certifications comprising a public key and a private key, coding with a transport key these certifications and sending them to the security module of a known user, said module comprising the transport key for decoding the certification.

The use of a tested security module such as the microprocessor of a user allows to avoid several exchanges for the dynamic creation of a transfer key.

These security modules have coding means and keys in security zones that particularly guarantee the secrecy of the private key.

In fact, according to the known solutions the various keys are generally stored in the mass memory of the computer, which implies the risk that they be tampered with.

The system of the invention also applies to the secured generation of certifications. The object sought by this system is to avoid having keys in clear during the generation process, while keeping short issuing times so as to satisfy a large demand.

### BRIEF DESCRIPTION OF THE DRAWING FIGURE

FIG. 1 is a block diagram illustrating the configuration of the generation system of certifications and private keys according to the invention.

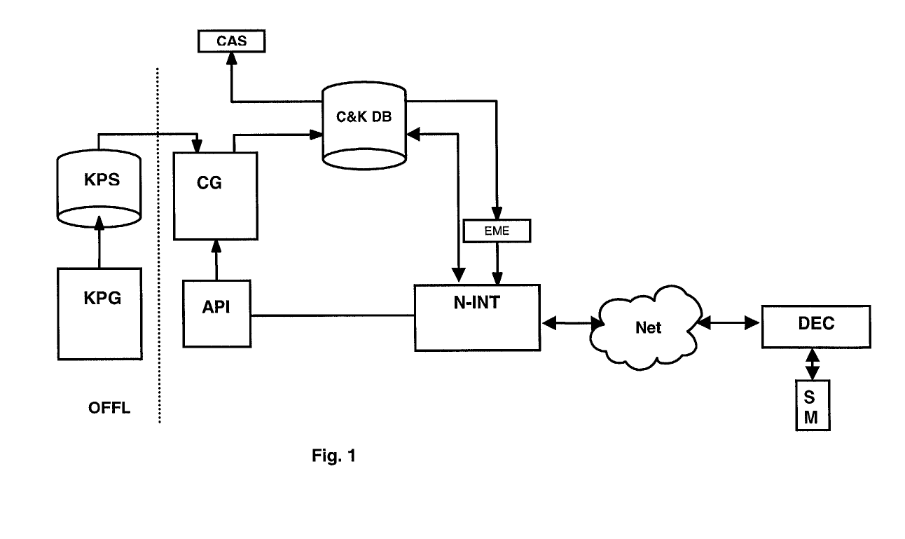

### DETAILED DESCRIPTION OF THE PREFERRED EMBODIMENTS

The invention will be better understood with the following detailed description referring to the annexed figure.

In this figure are diagrammatically represented the different modules in charge of the generation of certificates and keys. The generation as such of the pair private key and public key is carried out in the cryptographic module KPG according to a known technique in itself. Such a module is described in the application PCT/IB00/01589 and is based on the use of a great number of security units working in parallel. Once generated, the keys are directly encrypted in this same module by a service key of the system and transmitted under this form to the key data base KPS. This service key codes or decodes the locally stored data from the moment these confidential data leave the security module.

This stage is important because the generation of a pair of keys takes several seconds and the on-line generation (upon request) is thus too slow to satisfy the users. This is why the pairs of keys are generated and stored in the data base KPS for future use. The left part of the OFFL line concerns the generation of keys in off-line mode.

Upon request of the user, the encrypted keys are sent to the CG certificate generation module, certificate that contains the public key. The private key, always in encrypted form, as well as the certificate are stored in the C&K DB data base. Before sending the private key, it is previously decoded by the service key of the system and encrypted by the transmission key of the security module of the user. This key can either be a secret symetric key or the public key of the security module. This stage is carried out inside a high speed coding security module according to the architecture described in PCT/IB00/01589.

For future identification, the certificate of the Certification Authority can also be transmitted.

The encrypted private key as well as its certificate are transmitted to the final user by usual means by resource interface N-INT on the Internet.

In the applications of pay television it is possible to use the standard transmission forms of management of subscribers represented by the CAS module (Conditional Access System).

The transmission of such a certificate can be done either on the initiative of the centre or of the user unit.

The user unit DEC is not considered sufficiently secure for containing the private key. This is why the private key is sent, always in encrypted form, to the security module SM which only can decode this message. The private key is then stored in the protected memory of this module, which generally has the form of a smart card. The certificate, of greater size, is generally stored in the decoder as it does not contain confidential data.

When a transaction is initiated by the user, the signature is prepared in the security module by means of the private key. This key is in no moment accessible outside the security module.

According to one embodiment, the certificate and the signature are sent to the management centre. This management centre access the data base of the C&K DB certificates to verify the authenticity of the certificate and to use the public key of the user in order to decode the signature. In return, the centre sends its certificate with its signature. To form the latter the centre uses its private key stored in encrypted form in the same C&K DB data base. The key is transmitted to the signature module EME which is of the secured type. The key is then decoded in this module in order to compose the signature.

The signature and the certificate are then sent to the user's unit. The certificate of the centre transmitted when establishing the private key of the user is then used to decode and verify the signature.

The authentication is then ensured on both sides.

According to an embodiment, the public key of the centre is kept in the user's security module so that this important identification criterion cannot be modified.

I claim:

1. A method of production and distribution of asymetric public and private keys between a key generation centre and at least one user unit (DEC), said unit comprising a security module (SM), said method consisting in:
generating certificates comprising a public key and a private key in a first cryptographic unit (KPG),
coding the private key by means of a service key in the first cryptographic unit (KPG) and storing said private key in a key memory (KPS),
when sending the keys to a user unit, extracting the keys from the key memory (KPS), composing the certification with the public key,
decoding the corresponding private key by means of the service key in a cryptographic security module and coding it with a transport key of the user.

2. A method according to claim 1, characterised in that the encrypted private key is received by the user unit (DEC) and transmitted to the security module (SM) containing the transport key for decoding and storing the private key.

3. A method according to claim 1, characterised in that it consists in using several monolithic cryptographic unit to obtain a high speed coding module.

4. A method according to claim 1, characterised in that it consists in:
coding the public key of the centre with the transport key and transmitting it to the user unit (DEC),
receiving by the user unit, the encrypted public key and transmitting it to the security module (SM),
decoding and storing the public key by means of the transport key inside the security module (SM).

5. A method according to claim 2, characterised in that it consists in:
coding the public key of the centre with the transport key and transmitting it to the user unit (DEC),
receiving by the user unit, the encrypted public key and transmitting it to the security module (SM),
decoding and storing the public key by means of the transport key inside the security module (SM).

6. A method according to claim 3, characterised in that it consists in:
coding the public key of the centre with the transport key and transmitting it to the user unit (DEC),
receiving by the user unit, the encrypted public key and transmitting it to the security module (SM),
decoding and storing the public key by means of the transport key inside the security module (SM).
